(19) United States
(12) Patent Application Publication
(10) Pub. No.: US 2019/0269182 A1
(43) Pub. Date: Sep. 5, 2019

(54) HAND PROTECTOR

(71) Applicant: Chrome Cherry Limited, London (GB)

(72) Inventors: Pierre Radyn SWART, New York, NY (US); Riccardo FARRIS, London (GB); André PICCOLI VIGIL, Sutton (GB)

(21) Appl. No.: 15/910,164

(22) Filed: Mar. 2, 2018

(51) Int. Cl. A41D 13/08; A41D 31/00; A63B 71/14; B32B 5/02; B32B 7/12; B32B 25/10; B26F 1/38

(52) U.S. Cl. CPC A41D 13/082; B26F 2210/16; A63B 71/141; B32B 5/024; B32B 7/12; B32B 25/10; B26F 1/38; A41D 2400/22; A41D 2400/44; A41D 2400/80; A41D 2600/10; A41D 2600/20; B32B 2262/0261; B32B 2262/0276; B32B 2437/02; B26F 1/3866; A41D 31/0016

(57) ABSTRACT

A hand protector is disclosed that comprises flexible planar base in the general shape of an oversized palm of a person's hand. Five spaced apertures are provided towards edges of the planar base in positions that correspond to five fingers of the hand, the apertures sized to permit the fingers of the hand to be inserted therethrough to support the planar base against a palm of the hand. One or more of the apertures have cover flaps, each cover flap movable between a first position in which it generally extends in a plane of the base, and a second position in which it extends away from the plane of the base and abuts a base of the finger when a finger is inserted through the aperture.

### FIELD OF THE INVENTION

This invention relates to hand protection equipment such as gloves. More specifically, this invention relates to a hand protector that protects a palm of a hand during manual activities.

### BACKGROUND TO THE INVENTION

Various palm-protection gloves are available on the market. These gloves provide protection for the user's palms from friction due to various activities at the gym or around the home and garden whilst providing increased grip on the surface handled.

U.S. Pat. No. 5,479,660 to Najac discloses an exercise glove which includes a generally rectangular palm structure with one end being slightly curved and the other end having a generally straight edge for fitting comfortably under the middle joint of the fingers. A pair of straps with hook and loop connectors extend outwardly from the sides near the curved end to encircle the back of the hand.

U.S. Pat. No. 6,832,391 to Bower discloses a glove for protecting an individual's hand. The glove includes a palm covering shaped to substantially correspond to the shape of at least a portion of the palmar side of the individual's hand, and a back covering shaped to substantially correspond to the shape of at least a portion of the dorsal side of the individual's hand.

U.S. Pat. No. 5,781,928 to Avila describes a lightweight, padded, washable multi-purpose hand protector which can be combined with an elastic hand-wrap and comprising a fingerless half glove for baseball players, football players, boxers and martial artists to protect the hands and knuckles.

Many of these gloves are designed to cover a large portion of the hand which restricts the free movement of the user's fingers and results in faster sweat build-up. These full-cover gloves are usually size specific and consumers will need to spend time to find the correct size.

Alternative designs have been introduced to the market that provide more ventilation but usually make use of hook-and-loop fasteners to secure the glove to the user's hand. These fasteners tend to hook onto other objects of material in their near vicinity and can result in damaging the material.

Very minimalistic designs are also available in the form of single padded sheets; however, these generally do not provide effective attachment to the hand and may therefore have to be carried around in use.

The applicant believes there is a need for hand protectors that can be quickly secured to one's hands without the need for fasteners, are non-restrictive and lightweight for avoiding sweat build-up and with a minimal design for easy manufacture.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided a hand protector comprising:
a flexible planar base in the general shape of an oversized palm of a person's hand;
five spaced apertures provided towards edges of the planar base in positions that correspond to five fingers of the hand, the apertures sized to permit the fingers of the hand to be inserted therethrough to support the planar base against a palm of the hand; and
a cover flap for one or more of the apertures, each cover flap movable between a first position in which it generally extends in a plane of the base, and a second position in which it extends away from the plane of the base and abuts a base of the finger when a finger is inserted through the aperture.

Further features provide for each cover flap to have a free end that extends away from a central area of the planar base.

Further features provide for the apertures and the cover flaps to be formed by five arcuate slots in the material of the planar base, the material within each arcuate slot forming the cover flaps.

Further features provide for the arcuate slots to be U-shaped slots cut or stamped into the planar flexible base so that the cover flaps are formed by the material within the U-shaped slots.

Further features provide for the planar base to be made from two or more layers of sheet material secured together; for the sheet material to include a top layer of breathable material and a bottom layer of gripping material. The breathable material may be a breathable fabric such as nylon and the gripping material may be textured rubber or silicone. The layers may be secured together by an adhesive.

Further features provide for the hand protector to be washable.

Further features provide for the top layer to be provided with markings to indicate to a person the location of each cover flap.

The thickness of the flexible planar base may be between 0.5 mm to 5 mm, preferably from 2 mm to 4 mm.

The cover flaps, being in a second position in which they extend away from the plane of the base and abut a base of the finger, may shield a lower portion of the fingers to protect the lower portion from friction-induced injury. The cover flaps may also be sized to protect a ring on a finger from friction-induced damage. The cover flaps may engage the base of the finger and aid in securing the hand protector to the palm of the hand.

The apertures may provide a non-restrictive attachment means for the hand protector to the hand and may accommodate various hand and finger sizes. The planar base may provide for a lightweight hand protector and may avoid sweat build-up.

The invention extends to a method of manufacturing hand protectors, comprising:
providing a sheet of flexible material;
cutting or stamping a number of planar bases from the sheet of flexible material, each planar base being in the general shape of an oversized palm of a person's hand; and
cutting or stamping groups of five arcuate slots into the flexible material, each group of five arcuate slots positioned towards edges of each planar base in positions that correspond to five fingers of the hand, wherein the arcuate slots form apertures with movable cover flaps.

An embodiment of the invention will now be described, by way of example only, with reference to the accompanying drawings.

### BRIEF DESCRIPTION OF THE DRAWINGS

In the drawings:

FIG. 1 is a plan view of a hand protector according to a first embodiment;

FIG. 2 is a three-dimensional view of the hand protector viewed from a top left position;

FIG. 3 is a three-dimensional view of the hand protector viewed from a top right position;

FIG. 4 is a three-dimensional view of the hand protector secured to a right hand;

FIG. 5 is a plan view of a hand protector with fingerprint illustrations shown on the cover flaps according to a second embodiment;

FIG. 6A is a three-dimensional view from below of a hand protector according to an embodiment in which the hand protector is made from two layers of material;

FIG. 6B is an enlarged portion of FIG. 6A;

FIG. 7 is a bottom plan view of the hand protector of FIG. 6A; and

FIG. 8 is a top plan view of the hand protector of FIG. 6A.

### DETAILED DESCRIPTION WITH REFERENCE TO THE DRAWINGS

The present invention is directed at providing protection for a palm of a hand and a base of a hand's fingers while doing friction-related manual activities such as lifting weights, gardening and house work. During these activities it may be advantageous to employ the use of hand protection to avoid injuries which may include cuts, blisters or calluses that may form on any part of the hand, particularly on the skin of the palms, just below the fingers and on the base of the fingers. The present invention may be applied, but is not limited, to any activity that induces these and other similar injuries.

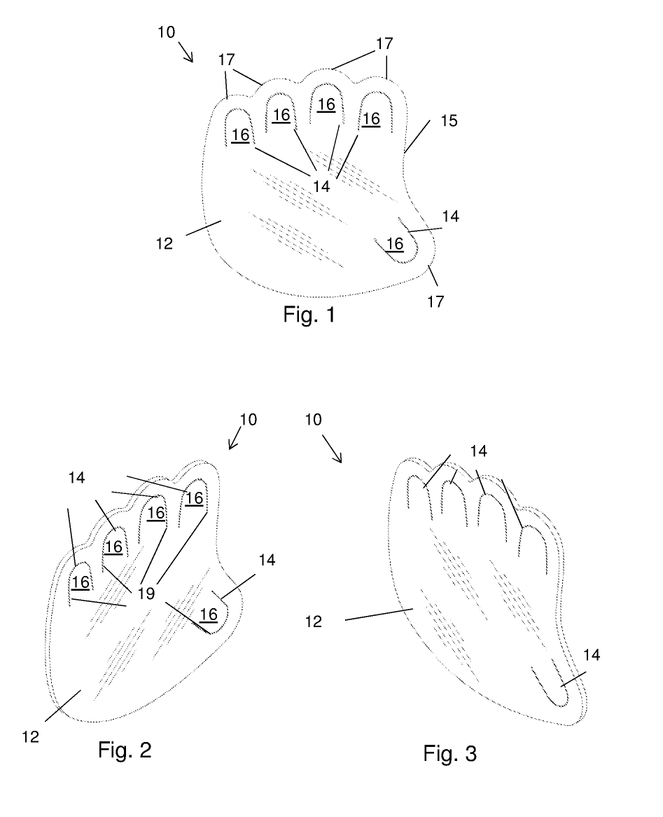

FIGS. 1 to 4 show an embodiment of a hand protector (10) that includes a flexible planar base (12) in the general shape of an oversized palm of a person's hand. Five spaced apertures (14) are located towards an undulating outer peripheral edge (15) of the planar base (12), each aperture adjacent a nose-like protrusion (17) in the planar base (12), in positions that correspond to five fingers of a person's hand. The planar base (12) is made of flexible material.

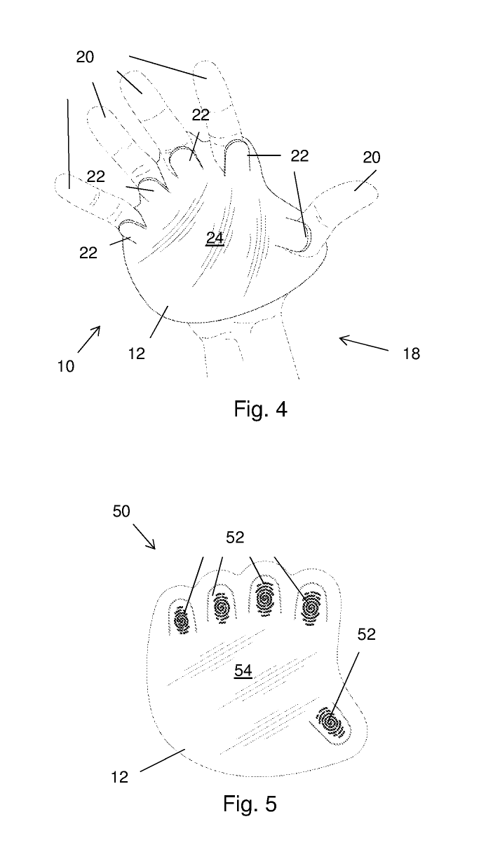

FIG. 2 clearly illustrates cover flaps (16) that may be formed by arcuate slots (19) in the material of the planar base (12) and the material within the arcuate slot (19) may form the cover flap (16). The arcuate slots (19) may be any suitable shape and in one embodiment may be U-shaped. The arcuate slots (19) may be formed in any way which may be by cutting or stamping into the flexible material of the planar base (12). The cover flaps (16) are movable between a first position in which it generally extends in a plane of the base as illustrated in FIGS. 1 to 3, and a second position in which it extends away from the plane of the base and abuts a base of the finger when a finger is inserted through the aperture as shown in FIG. 4.

FIG. 4 illustrates the hand protector (10) when in use and where fingers (20) of a hand (18) may protrude through any or all of the apertures (14) of the planar base (12). The hand protector (10) may be configured to be worn on either a left or a right hand. Each cover flap (16) has a free end (22) that extends away from a central area (24) of the planar base (12).

The aperture (14) size may vary and may vary from one another or may be similarly sized. The apertures (14) may be sized larger than the size of normal human fingers (20) to easily allow the fingers (20) of the hand (18) to pass therethrough. The shape of the apertures (14) may have a U-shaped configuration or any other suitable configuration. The planar base (12) may be supported by the fingers (20) of the hand (18) that extend through the apertures (14) and may aid in securing the hand protector (10) to a palm of the hand (18).

The cover flaps (16) may engage a base of the finger (20) and aid in securing the hand protector (10) to the palm of the hand (18). The cover flaps (16) may abut the base of the fingers (20) when the fingers (20) may protrude through the apertures (14). This may provide protection against friction-induced injury at the base of the fingers.

Further, the cover flaps (16) may protect jewelry such as a ring worn on one or more fingers (20) of a user, from damage. The cover flaps (16) may be provided for each of the apertures (14) or only one or more of the apertures (14). The size of the cover flaps (16) may vary in size and may be configured to be similar in size to the apertures (14). The cover flaps (16) may be any shape and in one embodiment may be U-shaped.

FIG. 5 illustrates another embodiment of a hand protector (50) with one or more markings (52), which may for example be fingerprint designs, and may be located on a top side (54) of the planar base (12). The markings (52) may indicate to a person the location of the cover flaps (16). In an embodiment of the invention the markings (52) may assist in establishing in which direction to insert the fingers (20) of the hand (18) into the apertures (14) and may thereby indicate on which hand (18) the hand protector (50) may be worn. Alternatively, the hand protector (50) may have no markings or have other markings that do not resemble fingerprints.

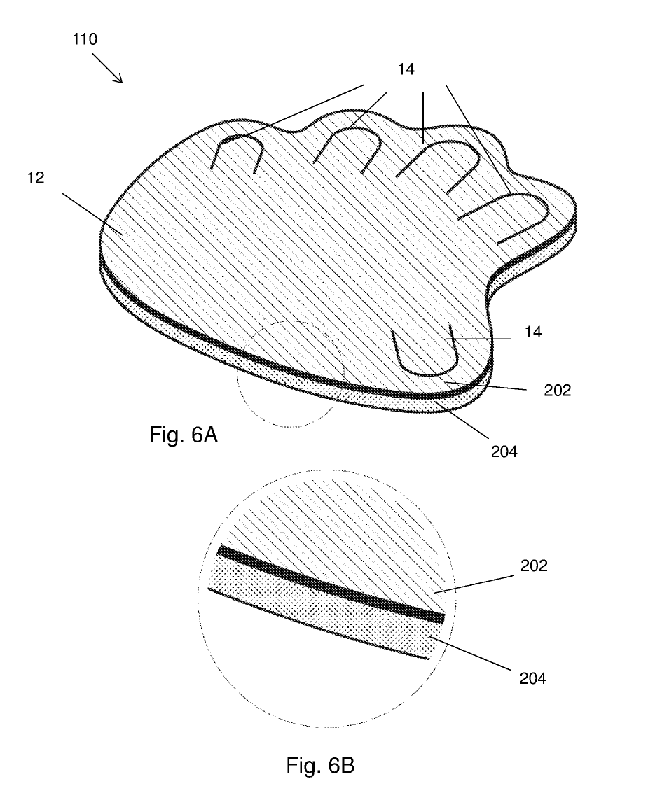

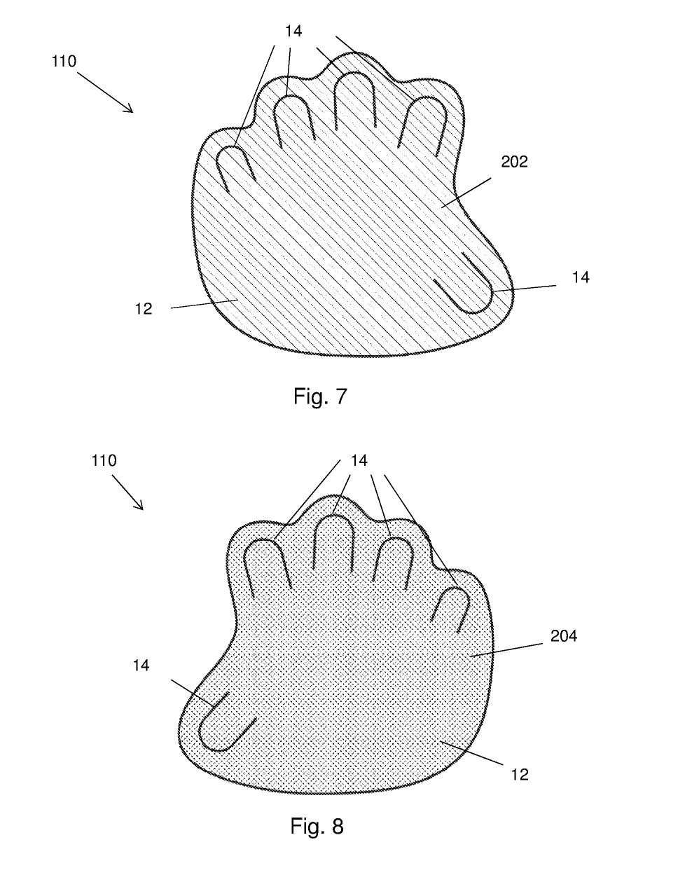

While the planar may be made from one layer of flexible material such as flexible rubber, it may also be made from two or more layers of flexible material secured together. FIGS. 6 to 8 illustrate an embodiment of a hand protector (110) where the planar base (12) may be made from two layers (202, 204) of flexible material secured together. The layers may comprise a breathable layer (202) selected from polymers which may comprise, but are not limited to, nylon and polyester. The layers may also comprise a gripping layer (204) made from printed or textured silicone or from textured rubber. Other possible materials for the gripping layer (204) include ethylene propylene diene monomer (EPDM) rubber, butyl rubber, natural rubber, synthetic rubber, sponge rubber, foam rubber, neoprene rubber and thermoplastic rubber. The breathable layer (202) is preferably a top layer which abuts the palm of the hand and the gripping layer (204) is a bottom layer which engages objects.

The layers of material (202, 204) may be secured together by a securing means. The securing means may be any number of means in which to secure two materials together and may be an adhesive. In the case that an adhesive may be used, the adhesive may be applied to one or more layers of the material (202, 204) to be secured together.

The hand protector (110) may be configured to be worn on a specific hand so that the gripping type of material (204) may face away from the palm of the user's hand and that the breathable type of material (202) may face towards the palm of the user's hand. Alternatively, the hand protector (110) may be worn so that the breathable type of material (202) may face away from the palm of the user's hand and may be used in a sliding application that may include sliding exercises in the gym or for any other suitable application.

The planar base (12) may be configured that one size can accommodate a number of hand sizes or can be differentially configured so that each configuration accommodates a different hand size.

The planar base (12) may be made from any type of flexible material. In one embodiment the planar base (12) may be made from a lightweight, flexible material. The material may aid in avoiding sweat build-up to a certain extent. Further, the flexible material may be washable either by hand or with a washing machine. The flexible material may vary in thickness. The thickness of the material of the flexible base may be between 0.5 mm and 5 mm and preferably between 2 mm and 4 mm. In some embodiments, the flexible material may be a very thin sheet of less than 1 mm so as to provide grip only, and may be a transparent flexible plastic sheet.

The invention may extend to a method of manufacturing the hand protectors (10; 50; 110) and it should be appreciated that the above description of the different embodiments of the hand protector (10; 50; 110) may be applied to the following mentioned components of the method. The method may comprise providing a sheet or sheets of flexible material (which may be made as one layer or with more than one layer as previously discussed) and cutting or stamping any number of planar bases (12) from the sheet or sheets of flexible material. Each planar base (12) may be in the general shape of an oversized palm of a person's hand (18). Groups of five arcuate slots (19) are then cut into the flexible material. Each group of five arcuate slots (19) may be positioned towards edges of each planar base (12) in positions that correspond to five fingers (20) of the hand (18). The arcuate slots (19) may form apertures (14) with movable cover flaps (16).

It will be appreciated that batch manufacturing in this manner is efficient and leads to minimal wastage of material.

The disclosure accordingly provides a lightweight, cost effective and simple hand protector that provides good ventilation to the hand while protecting the palm and base of the fingers. The cover flaps, being in a second position in which they extend away from the plane of the base and abut a base of the finger, may shield a lower portion of the fingers to protect the lower portion from friction-induced injury. The cover flaps may also be sized to protect a ring on a finger from friction-induced damage. The cover flaps may engage the base of the finger and aid in securing the hand protector to the palm of the hand. The apertures may provide a non-restrictive attachment means for the hand protector to the hand and may accommodate various hand and finger sizes.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A hand protector comprising:
a flexible planar base in the general shape of an oversized palm of a person's hand;
five spaced apertures provided towards edges of the planar base in positions that correspond to five fingers of the hand, the apertures sized to permit the fingers of the hand to be inserted therethrough to support the planar base against a palm of the hand; and
a cover flap for one or more of the apertures, each cover flap movable between a first position in which it generally extends in a plane of the base, and a second position in which it extends away from the plane of the base and abuts a base of the finger when a finger is inserted through the aperture.

2. A hand protector as claimed in claim 1, wherein each cover flap has a free end that extends away from a central area of the planar base.

3. A hand protector as claimed in claim 1, wherein the apertures and the cover flaps are formed by five arcuate slots in the material of the planar base, the material within each arcuate slot forming the cover flaps.

4. A hand protector as claimed in claim 3, wherein the arcuate slots are U-shaped slots cut or stamped into the flexible material of the base so that the cover flaps are formed by the material within the U-shaped slots.

5. A hand protector as claimed in claim 1, wherein the planar base is made from a single layer of flexible material.

6. A hand protector as claimed in claim 1, wherein the planar base is made from two or more layers of sheet material secured together.

7. A hand protector as claimed in claim 6, wherein the layers of sheet material include a top layer of breathable material and a bottom layer of gripping material.

8. A hand protector as claimed in claim 7, wherein the breathable material is a fabric selected from nylon and polyester.

9. A hand protector as claimed in claim 7, wherein the gripping material is a textured material selected from textured rubber and silicone.

10. A hand protector as claimed in claim 6, wherein the layers of sheet material are secured together by an adhesive.

11. A hand protector as claimed in claim 1, wherein the thickness of the flexible planar base is between 0.5 mm and 5 mm.

12. A hand protector as claimed in claim 1, wherein the thickness of the flexible planar base is between 2 mm and 4 mm.

13. A method of manufacturing hand protectors, comprising:
providing a sheet of flexible material;
cutting or stamping a number of planar bases from the sheet of flexible material, each planar base being in the general shape of an oversized palm of a person's hand; and
cutting or stamping groups of five arcuate slots into the flexible material, each group of five arcuate slots positioned towards edges of each planar base in positions that correspond to five fingers of the hand, wherein the arcuate slots form apertures with movable cover flaps.
